(19) United States
(12) Patent Application Publication
(10) Pub. No.: US 2021/0224551 A1
(43) Pub. Date: Jul. 22, 2021

(54) A SYSTEM AND METHOD FOR DEDUPLICATING PERSON DETECTION ALERTS

(71) Applicant: NEC CORPORATION, Tokyo, JAPAN (JP)

(72) Inventors: Hui Lam ONG, Singapore (SG); Wei Jian PEH, Singapore (SG); Hong Yen ONG, Singapore (SG); Satoshi YAMAZAKI, Singapore (SG)

(73) Assignee: NEC CORPORATION, Tokyo, JAPAN (JP)

(21) Appl. No.: 17/056,513

(22) PCT Filed: Mar. 8, 2019
(86) PCT No.: PCT/JP2019/009262

§ 371 Date: Nov. 18, 2020

(30) Foreign Application Priority Data
Jun. 12, 2018 (SG) 10201805030Y

(51) Int. Cl. G06K 9/00; G08B 13/196; G08B 29/18; G06F 17/11

(52) U.S. Cl. CPC G06K 9/00771; G06K 9/00744; G06F 17/11; G08B 13/19645; G08B 29/185; G08B 13/19608

(57) ABSTRACT

The present disclosure provides a method of generating an alert. The method comprises detecting, in an image frame, a unique parameter of an object using object recognition software; determining whether the detected unique parameter is associated with an object of interest; in response to determining that the detected unique parameter is associated with the object of interest, determining whether the associated object of interest has been detected within a deduplication period; in response to determining that the associated object of interest has been detected within the deduplication period, determining a detection score associated with the detected unique parameter; determining whether the detection score exceeds a minimal escalation threshold; and in response to determining that the detection score exceeding the minimal escalation threshold, generating an alert within the deduplication period.

### TECHNICAL FIELD

The present invention relates generally to image processing and, in particular, to a person detection alert deduplication in a video surveillance system.

### BACKGROUND ART

Computer-aided video surveillance systems have been developing rapidly in recent years. With the ever-increasing demand of video surveillance systems and limited manpower in monitoring all the video surveillance cameras, an automated person detection system has become a basic requirement in most video surveillance systems. The automated person detection system detects a person of interest in an image frame of a video, which is captured by a camera of the video surveillance system, and generates a detection alert to notify a user.

The effectiveness of the automated person detection system to detect a person is determined in part by the frame rate (i.e., the number of image frames per second) of a video that is captured by a video surveillance camera. FIGS. 1A and 1B show the impact of the frame rate configuration of a video surveillance camera on the effectiveness of the automated person detection system.

FIG. 1A is an example of a video surveillance camera having a frame rate of 1 image frame per second. That is, the video surveillance camera generates an image frame (110A, 110F) every second. An image frame (110B, 110F) captures a scene at an instant of time.

FIG. 1B is an example of a video surveillance camera having a frame rate of 5 frames per second. That is, the video surveillance camera generates 5 image frames (110A, 110B, 110C, 110D, 110E) every second.

In the example shown in both FIGS. 1A and 1B, a person 102 runs across the view of the camera. In the example shown, the frame 110A of both the cameras of FIGS. 1A and 1B captures the scene before the person 102 enters the scene. The frame 110F of both cameras of FIGS. 1A and 1B, however, captures the scene after the person 102 leaves the scene. Therefore, in FIG. 1A, a camera with a frame rate of 1 per second does not capture the person 102 running across the scene. The video surveillance camera of FIG. 1A therefore completely misses the running person 102 as the person 102 does not appear in any of the frames captured by the camera of FIG. 1A. As denoted by the question marks in FIG. 1A, a video surveillance system having a camera with a frame rate of 1 per second misses out on information between the frames.

However, if the camera has a higher frame rate (e.g., 5 frames/second as shown in FIG. 1B), then such a camera has a higher chance of capturing the person 102. As shown in FIG. 1B, the frames 110B to 110D capture the person 102 as the person 102 runs across the scene.

For an environment where the amount of movement is low and/or slow, a camera with a lower frame rate can be used to reduce the traffic. For example, a video surveillance system monitoring a payment counter can have a lower frame rate as customers queuing to make payment move slowly.

On the other hand, an environment where the amount of movement is high and/or fast, a camera with a higher frame rate is required. For example, a video surveillance system monitoring a train platform requires a high frame rate due to the high amount of human traffic movement.

Therefore, a camera with a higher frame rate is required in certain environments for a higher chance in capturing an object that moves across a scene that is being captured by the camera. However, a higher frame rate means that more information is generated by the camera, which in turn generates higher traffic and load to the automated person detection system.

Another problem that exists for a camera with a higher frame rate is that such a camera generates a lot of alerts when a detected person is stationary (or moves slowly) through a scene.

### SUMMARY OF INVENTION

### Technical Problem

In one conventional arrangement, a deduplication period is introduced to the automated person detection system to suppress the number of alerts being generated. A deduplication period is a period of time where duplicate or redundant information (which in this case is an alert) is eliminated. For example, FIG. 2A shows an example of 5 alerts (210A, 210B, 210C, 210D, 210E) being generated, but the alerts 210B, 210C, and 210D are generated during a deduplication period and are eliminated. This arrangement results in lower alert processing and prevention of incoming alert flooding the video surveillance system. However, there is a high chance of important alert information being lost during the deduplication period.

In another conventional arrangement, all of the alerts are processed and sent. However, the video surveillance system aggregates the alerts received within a certain period of time and only displays the number of aggregated alerts within that period of time. That is, once the period ends, the aggregated alerts are displayed on a display. FIG. 2B shows an example of such aggregation of the alerts 220A and 220B. This arrangement results in a better user interface usability. However, this arrangement does not have a deduplication period, which results in higher alert processing and traffic load.

In yet another arrangement, the alerts are processed and similar alerts are aggregated. Once a particular type of alert has occurred a number of pre-defined threshold, the alert is sent. This arrangement reduces the processing of alerts and prevents a flood of alerts being sent to the user interface. However, there is a possibility of losing early alert information as alerts are aggregated before being sent.

### Solution to Problem

It is an object of the present invention to substantially overcome, or at least ameliorate, one or more disadvantages of existing arrangements.

According to a first aspect of the present disclosure, there is provided a method of generating an alert, the method comprising:

detecting, in an image frame, a unique parameter of an object using object recognition software;

determining whether the detected unique parameter is associated with an object of interest;

in response to determining that the detected unique parameter is associated with the object of interest, determining whether the associated object of interest has been detected within a deduplication period;

in response to determining that the associated object of interest has been detected within the deduplication period, determining a detection score associated with the detected unique parameter;

determining whether the detection score exceeds a minimal escalation threshold; and

in response to determining that the detection score exceeding the minimal escalation threshold, generating an alert within the deduplication period

According to a second aspect of the present disclosure, there is provided a system for generating an alert, the system comprising:

a processor;

a peripheral device in communication with the processor, the peripheral device is configured to generate the alert; and

memory in communication with the processor, the memory storing a computer program recorded therein, the computer program being executable by the processor to perform a method of generating the alert, said method comprising: detecting, in an image frame, a unique parameter of an object using object recognition software;

determining whether the detected unique parameter is associated with an object of interest;

in response to determining that the detected unique parameter is associated with the object of interest, determining whether the associated object of interest has been detected within a deduplication period;

in response to determining that the associated object of interest has been detected within the deduplication period, determining a detection score associated with the detected unique parameter;

determining whether the detection score exceeds a minimal escalation threshold; and

in response to determining that the detection score exceeding the minimal escalation threshold, generating, by the peripheral device, the alert within the deduplication period.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects are also disclosed.

### BRIEF DESCRIPTION OF DRAWINGS

Some aspects of the prior art and at least one embodiment of the present invention will now be described with reference to the drawings and appendices, in which:

FIG. 1A shows the impact of cameras with different frame rates on a video surveillance system;

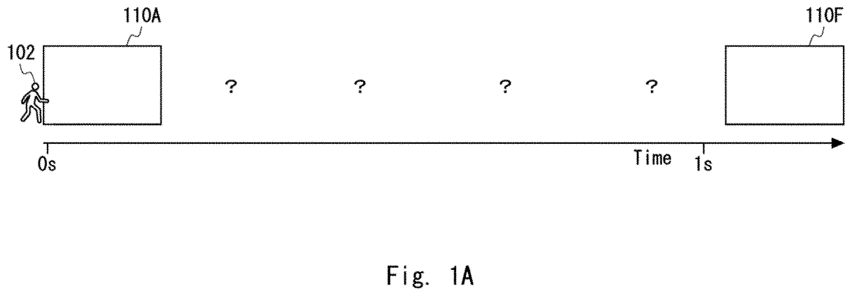

FIG. 1B shows the impact of cameras with different frame rates on a video surveillance system;

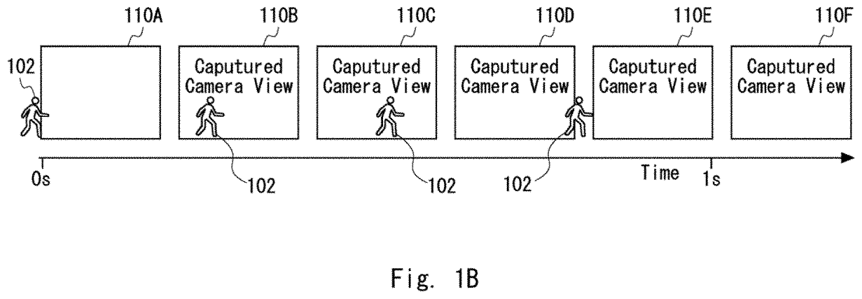

FIG. 2A shows examples of conventional arrangements in reducing the number of alerts being generated by conventional video surveillance systems;

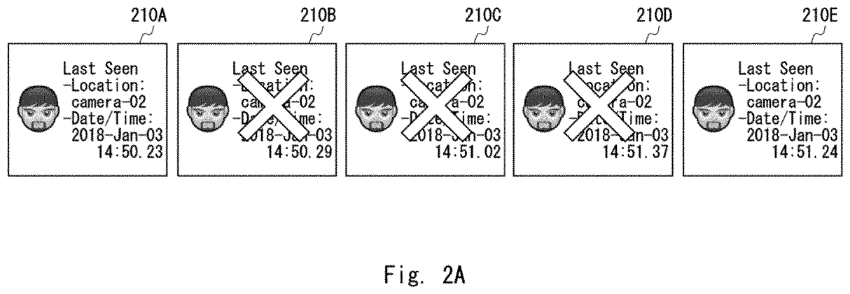

FIG. 2B shows examples of conventional arrangements in reducing the number of alerts being generated by conventional video surveillance systems;

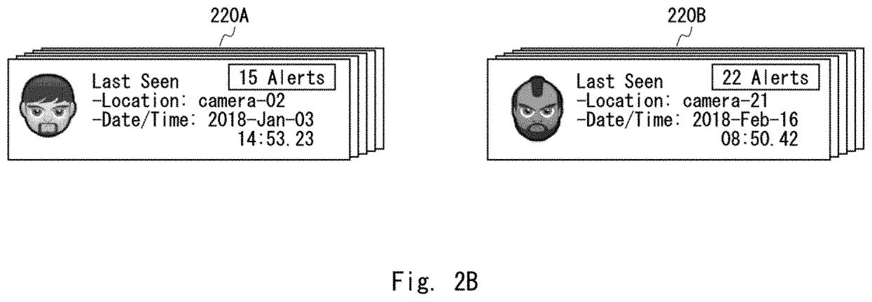

FIG. 3 illustrates a schematic block diagram of a general purpose computer system upon which arrangements described can be practiced;

FIG. 4A is a flow diagram of a method of detecting an object of interest according to the present disclosure;

FIG. 4B is a flow diagram of an alternative method of detecting an object of interest according to the present disclosure;

FIG. 5A illustrates the values of the variables Yaw and Pitch that are used in the method of FIG. 4; and

FIG. 5B depicts the effect of difference camera view angles.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to conventional arrangements relate to discussions of devices which form public knowledge through their use. Such should not be interpreted as a representation by the present inventor(s) or the patent applicant that such devices in any way form part of the common general knowledge in the art.

### Structural Context

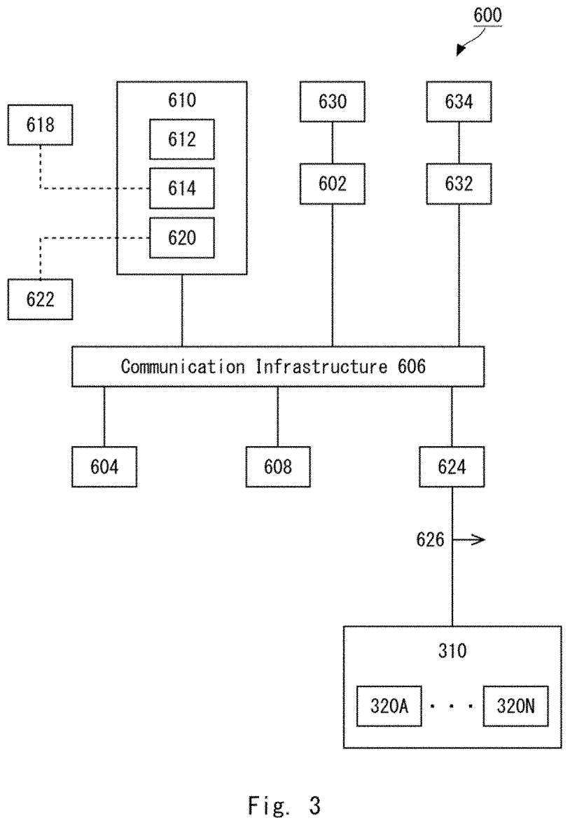

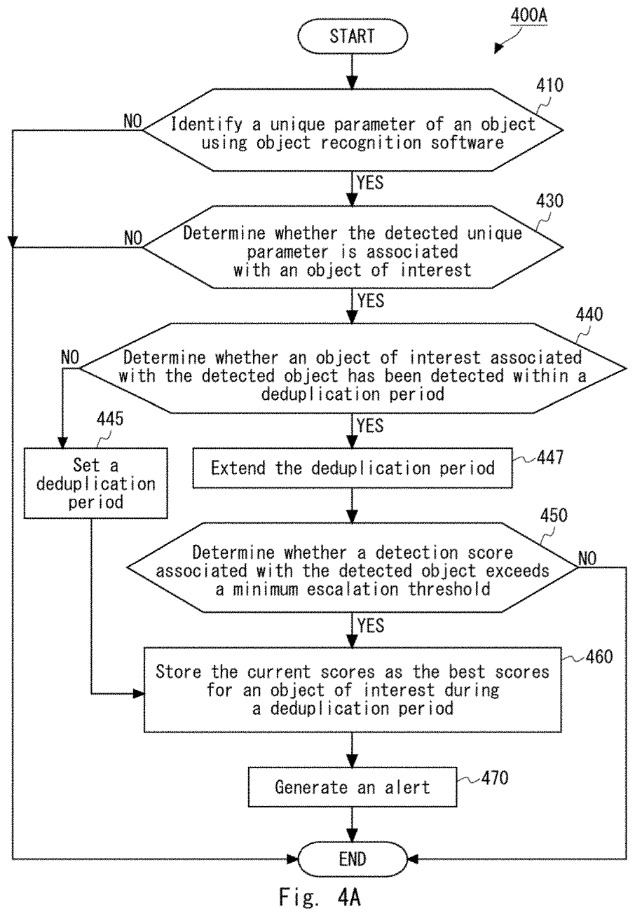

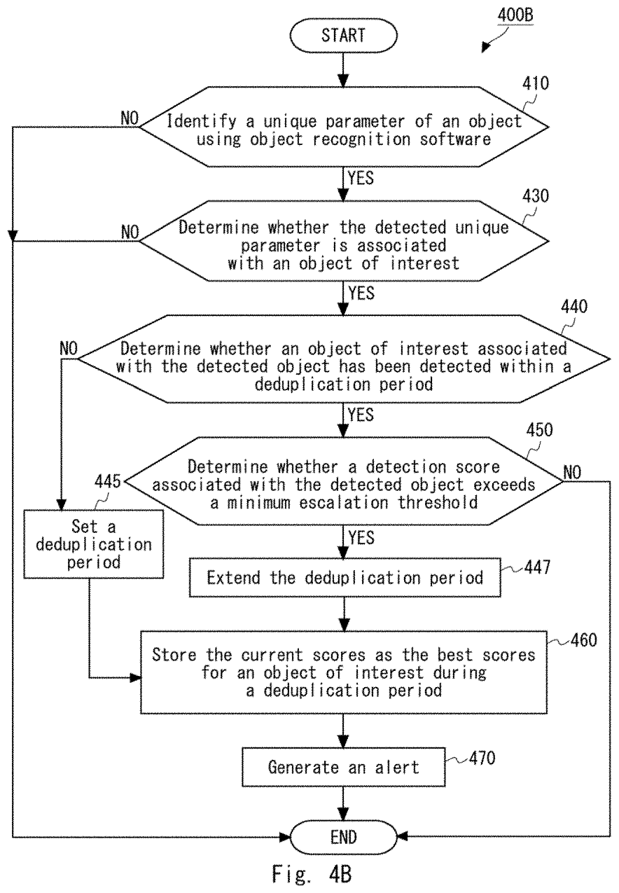

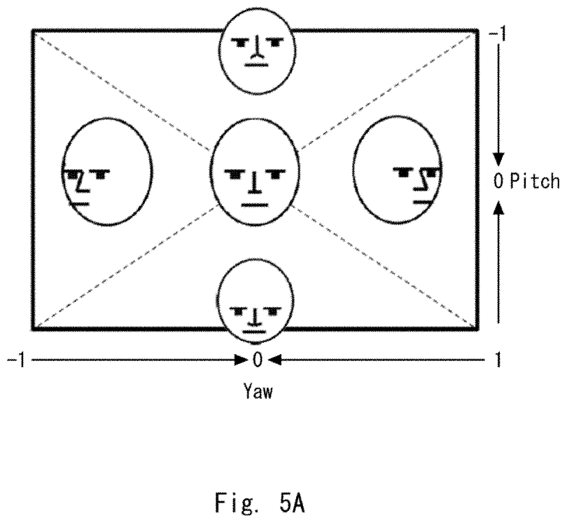

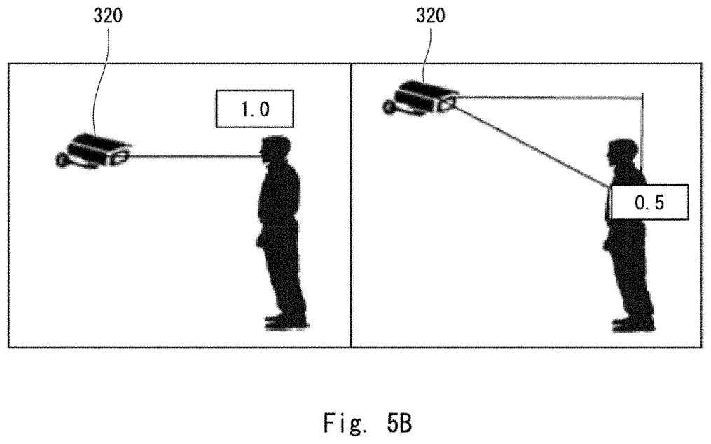

FIG. 3 depicts an exemplary computer/computing device 600, hereinafter interchangeably referred to as a computer system 600, where one or more such computing devices 600 may be used to facilitate execution of a method of generating alerts as described below in relation to FIGS. 4, 5A, and 5B. The following description of the computing device 600 is provided by way of example only and is not intended to be limiting.

As shown in FIG. 3, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 618 in a well-known manner. The removable storage medium 618 may include magnetic tape, optical disk, non-volatile memory storage medium, or the like, which is read by and written to by removable storage drive 614. As will be appreciated by persons skilled in the relevant art(s), the removable storage medium 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices (e.g., the video surveillance system 310) via a communication path 626. In various aspects of the present disclosure, the communication interface 624 permits data to be exchanged between the computing device 600 and a data communication network, such as a public data or private data communication network. The communication interface 624 may be used to exchange data between different computing devices 600 where such computing devices 600 form part an interconnected computer network. Examples of a communication interface 624 can include a modem, a network interface (such as an Ethernet card), a communication port (such as a serial, parallel, printer, GPIB, IEEE 1394, RJ25, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

In one arrangement, the communication interface 624 receives data from a video surveillance system 310 via the communication path 626. The video surveillance system 310 includes cameras 320A to 320N. Collectively, the cameras 320A to 320N will be referred to as “the cameras 320.” When referring to one of the cameras 320, the term “the camera 320” will be used hereinafter.

As shown in FIG. 3, the computing device 600 further includes a display interface 602 which performs operations for rendering images to an associated display 630 and an audio interface 632 for performing operations for playing audio content via associated speaker(s) 634. The display 630 and the speakers 634 are peripheral devices that are connected to the computing device 600. The computing device 600 may further include other peripheral devices.

The computing device 600 receives a video from each of the cameras 320 and uses an alert generation method 600 (described hereinafter in relation to FIGS. 4, 5A, and 5B) to transmit an alert to the display 630 and optionally the speaker 634 when an object of interest is detected in the received video. The display 630 and the speaker 634 in turn respectively displays and sounds the alert.

As used herein, the term “computer program product” may refer, in part, to removable storage medium 618, removable storage unit 622, or a hard disk installed in storage drive 612. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 3 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

### Alert Generation Method

When the computing device 600 receives a video from any of the cameras 320, the computing device 600 processes each video to determine whether an object of interest has been captured in the received video. A video includes image frames as described above. Hereinafter, the terms “image frame” and “frame” are the same and are interchangeably used. An object of interest can be a person, a vehicle, and the like.

FIGS. 4A and 4B show flow charts of methods 400A and 400B of generating an alert when an object of interest is detected in a frame of a video received from the camera 320. Collectively, the methods 400A and 400B will be referred to as the method 400. The method 400 can be implemented as software that is stored in the storage medium 618, the removable storage unit 622, or the hard disk installed in the storage drive 612. The software is then readable and executable by the processor 604.

The method 400 is performed on each frame of the video received by the computing device 600 to determine whether a person of interest has been captured in the frame and whether an alert needs to be generated.

The method 400 commences at step 410 by identifying a unique parameter of an object using object recognition software in a frame of a video received from the camera 320. For example, the unique parameter for a person is a face. In another example, the unique parameter of a vehicle is a license plate. The unique parameters are dependent on the object that is to be identified.

When recognising a face of a person of interest, face recognition software that can be used are NEC NeoFaceV, and the like. The face recognition software determines whether a face (i.e., the unique parameter) is present in the frame.

When recognising a license plate of a vehicle, license plate recognition software can be used to identify the license plate. Hereinafter, the method 400 will be described in relation to identifying a face and a person of interest. However, as can be appreciated, the method 400 is applicable to other objects like a vehicle.

If there is an identifiable unique parameter (YES), the object recognition software identifies features of the unique parameters from a frame and provides a feature score for each of the features. In the case of a face, the face recognition software identifies facial features (e.g., nose length, jawline shape, eye width, eyebrow shape, eyebrow length, etc.) from a frame and provides a facial feature score for each of the facial features. The method 400 then proceeds from step 410 to step 430.

If there is no identifiable unique parameter (e.g., a face) in the frame (NO), the method 400 concludes at the conclusion of step 410.

In step 430, the method 400 determines whether the detected unique parameter is associated with an object of interest. The computing device 600 stores an object of interest list having an identifier (e.g., name, nicknames, vehicle type, vehicle brand, and the like), the unique parameter (e.g., a face), and feature scores corresponding to the unique parameter for each object of interest. The object of interest list is stored in the storage medium 618, the removable storage unit 622, or the hard disk installed in the storage drive 612. In one alternative arrangement, the object of interest list is stored in an external database that is accessible to the computing device 600 via the communication path 624.

In the case of a person, it is determined whether the unique parameter (e.g., a face) is associated with a person of interest. The object of interest list has an identifier (e.g., a name, a nickname, and the like), a face, and facial feature scores corresponding to the face of each person of interest.

The facial feature scores of the detected face can then be compared against the facial feature scores of each person of interest to determine whether the detected face is one of the persons of interest on the list. A matching score M1 is then generated for each person of interest on the list from the facial feature score comparison.

In one arrangement, the matching score is the aggregate score difference of the compared facial feature scores between the detected face and the person of interest on the list. The matching score therefore provides an indication whether the detected face matches with a face of a particular person of interest on the list.

When a matching score M1 exceeds a predetermined threshold, a match between the detected face and the particular person of interest is determined and the detected face is assigned the identifier associated with that particular person of interest.

A frontal face score F1, which is associated with the matching score M1, is also calculated in step 430. See the discussion below in relation to step 450 for calculating the frontal face score F1.

When a unique parameter (e.g., a face) is determined to be matched with an object (e.g., a person) of interest (YES), the method 400 proceeds from step 430 to step 440. However, if the method 400 determines that the detected unique parameter (e.g., a face) does not match with any of the objects (e.g., persons) on the list (NO), the method 400 concludes at the conclusion of step 430.

In step 440, the method 400 determines whether the object of interest associated with the detected unique parameter has been detected within a deduplication period. The deduplication period is a silent period in which alerts pertaining to a particular object (e.g., a person) of interest is reduced to eliminate duplicate data and to reduce processing load. The deduplication period is a predetermined period of time from the first time that the object (e.g., a person) of interest is detected.

In one example, a person of interest is detected at 10 pm and a deduplication period is set to 5 minutes. Subsequent alerts for the same person of interest are suppressed until 10.05 pm. In conventional arrangements, no subsequent alerts are generated between 10 pm and 10.05 pm, which result in a high chance of important alert information being lost during the deduplication period. The method 400, however, generates an alert within the deduplication period (i.e., between 10 pm and 10.05 pm) if the detected person of interest has a better detection score (see below in relation to step 450).

After the deduplication period expires, the deduplication period for a particular object (e.g., a person) of interest is set to nil, which is the default value of the deduplication period.

The deduplication period of a particular object (e.g., a person) of interest is set to nil so that when an object (e.g., a person) of interest is detected outside a deduplication period (e.g., for the first time, after the expiry of a deduplication period), the method 400 generates an alert. That is, if an object (e.g., a person) of interest is detected for the first time or outside a deduplication period of that object (e.g., person) of interest, the method 400 proceeds to steps 445, 460, and 470 to generate an alert to indicate that the object (e.g., person) of interest has been detected by the video surveillance camera system 310.

If the object (e.g., person) of interest is detected within a deduplication period (YES), the method 400A proceeds from step 440 to step 447, while the method 400B proceeds from step 440 to step 450. Otherwise (NO), the method 400 proceeds from step 440 to step 445.

In step 445, the method 400 sets a deduplication period for a particular person of interest. As discussed above in relation to step 440, the deduplication period can be set to 5 minutes. In one arrangement, a deduplication period set from an object identified by a specific camera 320 is only used for the same object identified by that specific camera 320. In an alternative arrangement, a deduplication period set from an object identified by a specific camera 320 is used for the same object identified by other cameras 320 in the video surveillance system 310. In the alternative arrangement, the cameras 320 that share a deduplication period can be cameras 320 that are surveying a particular location (e.g., a lobby of a building, rooms of a building). The cameras 320 sharing a deduplication period is manually predetermined by a user when setting up the video surveillance system 310. The method 400 then proceeds from step 445 to step 460.

In step 447, the method 400 extends the deduplication period. The deduplication period can be extended by a predetermined period of time (e.g., 5 minutes, 6 minutes, etc.). For the method 400A, the deduplication period is extended whenever an object of interest associated with the detected object is detected within the deduplication period. For the method 400B, the deduplication period is extended when a detection score associated with the detected object exceeds a minimum escalation threshold. For the method 400A, the method 400A proceeds from step 447 to step 450. For the method 400B, the method 400B proceeds from step 447 to step 460.

In one alternative arrangement, step 447 is omitted so that the deduplication period is not extendible.

In step 450, the method 400 determines whether a detection score associated with the detected unique parameter (e.g., a face) exceeds a minimum escalation score.

First, the detection score is calculated. In one alternative arrangement, the detection score is calculated in step 430 when calculating the matching score M1.

The detection score for a face is calculated as follows:

A detection score=(max(abs(M2−M1),Tm)*W1)+((Tc+abs(F2−F1))*W2) (1)

### Where:

M2 is the best matching score during the deduplication period for a particular person of interest;
M1 is the matching score between the detected face and the particular person of interest;
F2 is the frontal face score associated with M2;
F1 is the frontal face score associated with M1;
W1 is the weighting for the matching score;
W2 is the weighting for the frontal face score;
Tm is the minimum matching threshold; and
Tc is the frontal face camera angle adjustment threshold.

M2 is stored in the storage medium 618, the removable storage unit 622, or the hard disk installed in the storage drive 612 of the computing device 600. The storing of M2 is discussed below in relation to step 460 of the method 400.

In calculating the detection score, the absolute difference in the matching scores M2 and M1 is first compared with the minimum matching threshold (Tm). The higher of the two values (i.e., the absolute difference in matching scores M1 and M2 and the minimum matching threshold (Tm)) is selected by the function max( ). Tm is the minimum delta value between the matching scores M2 and M1. The value selected by the max( ) function is then weighted according to the weight W1.

The detection score calculation also takes into account the view angle of the camera 320 capturing the frame, which is currently being processed by the method 400. The view angle of the camera 320 is taken into account by the frontal face scores F1 and F2.

A frontal face score F1 or F2 can be calculated using the following equation:

Frontal face score=1.0−(abs(Yaw)+abs(Pitch))/2 (2)

FIG. 5A shows the values of the variables Yaw and Pitch depending on the yaw and pitch of the face captured by the camera 320.

FIG. 5B shows two examples of calculating the frontal face scores at two different camera view angles. The left diagram of FIG. 5B shows a camera 320 pointing directly toward the face of a person, resulting in a perfect frontal face score of 1.0 as the values of both of the variables Yaw and Pitch are 0.

The right diagram of FIG. 5B shows a camera 320 with a camera view angle that is pointing downward to capture the face of a person. Accordingly, the camera 320 in FIG. 5B can only get a maximum frontal face score of 0.5 due to the Pitch value of 1, in accordance with equation (2).

F2 is stored in the storage medium 618, the removable storage unit 622, or the hard disk installed in the storage drive 612 of the computing device 600. The storing of F2 is discussed below in relation to step 460 of the method 400.

The absolute difference in frontal face scores F2 and F1 is then adjusted by the frontal face camera angle adjustment threshold Tc. Frontal face camera angle adjustment threshold is a value to adjust the frontal face score according to the pitch and yaw angles of the detected face. The frontal face adjustment score is camera specific and can be obtained by performing tests during a setup phase of the camera 320 or by using an equation which takes into account a camera view angle and distance of a camera 320.

Therefore, the frontal face camera angle adjustment is a threshold to normalize the frontal face score F1, as the cameras 320 take a video of the scene at different view angles.

The adjusted frontal face score is then weighted according to the weight W2. The detection score can then be obtained using equation (1).

In one alternative arrangement, the frontal face scores can be disregarded by setting the weight W2 to 0.

The detection score for a face can be adapted to be used for a license plate and other unique parameters. For example, F1 and F2 could be frontal license plate scores when the unique parameter is a license plate for identifying a vehicle. In general, frontal scores refer to frontal scores of a unique parameter (e.g., a face). Further, in general, Tc is the frontal camera angle adjustment threshold.

Second, the detection score is compared against a minimum escalation threshold score (Te). If the detection score is higher than the minimum escalation threshold score (Te) (YES), the method 400A proceeds from step 450 to step 460 while the method 400B proceeds from step 450 to step 447 (see above for discussion on step 447). Otherwise (NO), the method 400 concludes at the conclusion of step 450.

In step 460, the method 400 stores the current scores M1 and F1 as the best scores M2 and F2, respectively, for a particular object (e.g., person) of interest during a deduplication period.

Accordingly, the current matching score M1 is stored as the matching score M2. Also, in the face example, the current frontal facial score F1 is stored as the frontal face score F2. As described in step 450, both of the scores M2 and F2 are used for calculating a detection score for a person of interest during a deduplication period. When the deduplication period ends, the computing device 600 resets the scores of M2 and F2. The method 400 then proceeds from step 460 to step 470.

In step 470, the method 400 generates an alert. The alert is generated by displaying an alert on the display 630 and/or by generating a sound through the speaker 634. The method 400 then concludes at the conclusion of step 470.

Examples of the operation of the method 400 will now be described.

### First Example

In the first example, the method 400A is used and the deduplication period is used by one camera 320. In other words, the deduplication period is not shared among the cameras 320.

In one example, a person enters an area that is under the surveillance of the video surveillance system 310 at 10 pm. A camera 320 of the video surveillance system 310 captures the scene of the person entering the area and transmits the captured frame to the computing device 600, which in turn executes the method 400A to determine whether to generate an alert for the detected person.

The method 400A detects (in step 410) the face of the detected person using the face recognition software and determines (in step 430) whether the detected face is associated with a person of interest. As described above, in step 430, a matching score M1 and a frontal face score F1 are calculated. If the detected face is not a person of interest, then no alert is generated and the computing device 600 proceeds to the next frame to be processed. However, if the detected face is associated with a person of interest, the method 400A determines (in step 440) whether the same person of interest has been detected in a deduplication period (e.g., between 10 pm and 10.05 pm).

In this example, the person has been identified as a person of interest. As the person has just entered the area, then the captured frame is the first instance of the person of interest being detected and the deduplication period for this person of interest is at the default value of nil. Accordingly, method 400A sets (in step 445) a deduplication period. In this example, the deduplication period is 5 minutes so the deduplication period is between 10 pm and 10.05 pm. The method 400A then stores (in step 460) the matching score M1 and the frontal face score F2 as the scores M2 and F2, respectively. The method 400A then generates (in step 470) an alert.

At 10.02 pm, the same person is captured by the same camera 320. The computing device 600 receives the frame and executes the method 400A to determine whether to generate an alert for the detected person. The method 400A executes the steps 410 and 430, which generates a current matching score M1 and an associated frontal face score F1. In step 440, as the same person of interest is detected within the deduplication period of 10 pm and 10.05 pm, the method 400A extends (in step 447) the deduplication period. In this example, the extension period is 5 minutes and therefore the deduplication period is extended to 10.07 pm. The method 400A then determines (in step 450) whether a detection score associated with the detected face exceeds a minimum escalation threshold.

In step 450, a detection score is calculated based on the current scores M1 and F1 (at 10.02 pm) and the best scores M2 and F2 (which are the scores of the detected face at 10 pm). In this example, the detection score is lower than the minimum escalation threshold and the method 400A ends without generating an alert.

At 10.04 pm, the same person is captured by the same camera 320. The computing device 600 receives the frame and executes the method 400A to determine whether to generate an alert for the detected person. The method 400A executes the steps 410 and 430, which generates a current matching score M1 and an associated frontal face score F1. In step 440, as the same person of interest is detected within the deduplication period of 10 pm and 10.07 pm, the method 400A extends (in step 447) the deduplication period by 5 minutes to 10.09 pm. The method 400A determines (in step 450) whether a detection score associated with the detected face exceeds a minimum escalation threshold.

In step 450, a detection score is calculated based on the current scores M1 and F1 (at 10.04 pm) and the best scores M2 and F2 (which are the scores of the detected face at 10 pm). In this example, the detection score is higher than the minimum escalation threshold and the method 400A proceeds to step 460.

In step 460, the current scores M1 and F1 (at 10.04 pm) are respectively stored as the best scores M2 and F2. The method 400A then generates (in step 470) an alert for the person of interest. The method 400 then concludes.

If the same camera 320 does not detect the same person of interest again, the deduplication period ends at 10.09 pm and is reset to nil. Further, the scores M2 and F2 are reset.

When the method 400B is used for the first example, the deduplication period is not extended at 10.02 pm when the same person is detected by the same camera 320. This is because the method 400B extends the deduplication period when a detection score exceeding a minimum escalation threshold is determined (see step 447 for the method 400B). Therefore, when the method 400B is used, the deduplication period of the first example is not extended at 10.02 pm as the detection score is lower than the minimum escalation threshold. The deduplication period however is extended at 10.04 pm to 10.09 pm as the detection score at 10.04 pm exceeds the minimum escalation threshold.

### Second Example

In the second example, the method 400A is used and the deduplication period is used by a set of the cameras 320. In other words, the deduplication period is shared among the set of cameras 320. The set of cameras 320 could for example be surveying a particular location (e.g., a lobby of a building, rooms of a building, etc.).

In one example, a person enters the particular location that is under the surveillance of the video surveillance system 310 at 10 pm. A camera 320A from the set of cameras 320 captures the scene of the person entering the particular location and transmits the captured frame to the computing device 600, which in turn executes the method 400A to determine whether to generate an alert for the detected person.

The method 400A detects (in step 410) the face of the detected person using the face recognition software and determines (in step 430) whether the detected face is associated with a person of interest. As described above, in step 430, a matching score M1 and a frontal face score F1 are calculated. If the detected face is not a person of interest, then no alert is generated and the computing device 600 proceeds to the next frame to be processed. However, if the detected face is associated with a person of interest, the method 400A determines (in step 440) whether the same person of interest has been detected in a deduplication period (e.g., between 10 pm and 10.05 pm).

In this example, the person has been identified as a person of interest. As the person has just entered the area, then the captured frame is the first instance of the person of interest being detected and the deduplication period for this person of interest is at the default value of nil. Accordingly, method 400A sets (in step 445) a deduplication period. In this example, the deduplication period is 5 minutes so the deduplication period is between 10 pm and 10.05 pm. The method 400A then stores (in step 460) the matching score M1 and the frontal face score F2 as the scores M2 and F2, respectively. The method 400A then generates (in step 470) an alert.

At 10.02 pm, the same person is captured by another camera 320B from the set of cameras 320. The computing device 600 receives the frame and executes the method 400A to determine whether to generate an alert for the detected person. The method 400A executes the steps 410 and 430, which generates a current matching score M1 and an associated frontal face score F1. In step 440, as the same person of interest is detected within the deduplication period of 10 pm and 10.05 pm, the method 400A extends (in step 447) the deduplication period. In this example, the extension period is 5 minutes and therefore the deduplication period is extended to 10.07 pm. The method 400A then determines (in step 450) whether a detection score associated with the detected face exceeds a minimum escalation threshold.

In step 450, a detection score is calculated based on the current scores M1 and F1 (at 10.02 pm) and the best scores M2 and F2 (which are the scores of the detected face at 10 pm). In this example, the detection score is lower than the minimum escalation threshold and the method 400A ends without generating an alert.

At 10.04 pm, the same person is captured by a camera (e.g., 320A, 320B, 320C, etc.) of the set of cameras 320. The computing device 600 receives the frame and executes the method 400A to determine whether to generate an alert for the detected person. The method 400A executes the steps 410 and 430, which generates a current matching score M1 and an associated frontal face score F1. In step 440, as the same person of interest is detected within the deduplication period of 10 pm and 10.07 pm, the method 400A extends (in step 447) the deduplication period by 5 minutes to 10.09 pm. The method 400A determines (in step 450) whether a detection score associated with the detected face exceeds a minimum escalation threshold.

In step 450, a detection score is calculated based on the current scores M1 and F1 (at 10.04 pm) and the best scores M2 and F2 (which are the scores of the detected face at 10 pm). In this example, the detection score is higher than the minimum escalation threshold and the method 400A proceeds to step 460.

In step 460, the current scores M1 and F1 (at 10.04 pm) are respectively stored as the best scores M2 and F2. The method 400A then generates (in step 470) an alert for the person of interest. The method 400 then concludes.

If no camera in the set of cameras 320 detects the same person of interest again, the deduplication period ends at 10.09 pm and is reset to nil. Further, the scores M2 and F2 are reset.

When the method 400B is used for the second example, the deduplication period is not extended at 10.02 pm when the same person is detected by a camera 320 in the set of cameras 320. This is because the method 400B extends the deduplication period when a detection score exceeding a minimum escalation threshold is determined (see step 447 for the method 400B). Therefore, when the method 400B is used, the deduplication period of the first example is not extended at 10.02 pm as the detection score is lower than the minimum escalation threshold. The deduplication period however is extended at 10.04 pm to 10.09 pm as the detection score at 10.04 pm exceeds the minimum escalation threshold.

### Third Example

In the third example, the method 400 (i.e., either the method 400A or 400B) is used and the deduplication period is used by a set of the cameras 320. In other words, the deduplication period is shared among the set of cameras 320. The set of cameras 320 could for example be surveying a particular location (e.g., a lobby of a building, rooms of a building, etc.). In the third example, the deduplication period is not extendible. That is, step 447 is not performed by the method 400.

In the third example, a person enters the particular location that is under the surveillance of the set of cameras 320 at 10 pm. A camera 320 from the set of cameras 320 captures the scene of the person entering the area and transmits the captured frame to the computing device 600, which in turn executes the method 400 to determine whether to generate an alert for the detected person.

The method 400 detects (in step 410) the face of the detected person using the face recognition software and determines (in step 430) whether the detected face is associated with a person of interest. As described above, in step 430, a matching score M1 and a frontal face score F1 are calculated. If the detected face is not a person of interest, then no alert is generated and the computing device 600 proceeds to the next frame to be processed. However, if the detected face is associated with a person of interest, the method 400 determines (in step 440) whether the same person of interest has been detected in a deduplication period (e.g., between 10 pm and 10.05 pm).

In this example, the person has been identified as a person of interest. As the person has just entered the particular location, then the captured frame is the first instance of the person of interest being detected and the deduplication period for this person of interest is at the default value of nil. Accordingly, method 400 sets (in step 445) a deduplication period. In this example, the deduplication period is 5 minutes so the deduplication period is between 10 pm and 10.05 pm. The method 400 then stores (in step 460) the matching score M1 and the frontal face score F2 as the scores M2 and F2, respectively. The method 400 then generates (in step 470) an alert.

At 10.02 pm, the same person is captured by another one of the set of cameras 320. The computing device 600 receives the frame and executes the method 400 to determine whether to generate an alert for the detected person. The method 400 executes the steps 410 and 430, which generates a current matching score M1 and an associated frontal face score F1. In step 440, as the same person of interest is detected within the deduplication period of 10 pm and 10.05 pm, the method 400 determines (in step 450) whether a detection score associated with the detected face exceeds a minimum escalation threshold.

In step 450, a detection score is calculated based on the current scores M1 and F1 (at 10.02 pm) and the best scores M2 and F2 (which are the scores of the detected face at 10 pm). In this example, the detection score is lower than the minimum escalation threshold and the method 400 ends without generating an alert.

At 10.04 pm, the same person is captured by another one of the set of cameras 320. The computing device 600 receives the frame and executes the method 400 to determine whether to generate an alert for the detected person. The method 400 executes the steps 410 and 430, which generates a current matching score M1 and an associated frontal face score F1. In step 440, as the same person of interest is detected within the deduplication period of 10 pm and 10.05 pm, the method 400 determines (in step 450) whether a detection score associated with the detected face exceeds a minimum escalation threshold.

In step 450, a detection score is calculated based on the current scores M1 and F1 (at 10.04 pm) and the best scores M2 and F2 (which are the scores of the detected face at 10 pm). In this example, the detection score is higher than the minimum escalation threshold and the method 400 proceeds to step 460.

In step 460, the current scores M1 and F1 (at 10.04 pm) are respectively stored as the best scores M2 and F2. The method 400 then generates (in step 470) an alert for the person of interest. The method 400 then concludes.

At 10.05 pm, the same person is captured by another one of the set of cameras 320. The computing device 600 receives the frame and executes the method 400 to determine whether to generate an alert for the detected person. The method 400 executes the steps 410 and 430, which generates a current matching score M1 and an associated frontal face score F1. In step 440, as the same person of interest is detected within the deduplication period of 10 pm and 10.05 pm, the method 400 determines (in step 450) whether a detection score associated with the detected face exceeds a minimum escalation threshold.

In step 450, a detection score is calculated based on the current scores M1 and F1 (at 10.05 pm) and the best scores M2 and F2 (which are the scores of the detected face at 10.04 pm). In this example, the detection score is lower than the minimum escalation threshold and the method 400 ends.

When the clock moves to 10.06 pm, the deduplication period is reset to nil and the scores M2 and F2 are reset.

The method 400 provides an improvement to conventional arrangements in generating alerts as subsequent alerts are generated when a person of interest detected by the cameras 320 has a better detection score than previous detection scores for the same person of interest.

The method 400 also takes into account detected facial features as well as camera parameters (e.g., camera view angle) to calculate the detection score.

The method 400 also reduces the processing load and traffic as an alert is generated when the person of interest detected by an automated person detection system has a better detection score than previous detection scores for the same person of interest. The method 400 also provides early alerts and prevents the loss of important alerts within a deduplication period.

### INDUSTRIAL APPLICABILITY

The arrangements described are applicable to the computer and data processing industries and particularly for generating alerts when a person of interest is detected by a video surveillance camera.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

For example, the whole or part of the exemplary embodiments disclosed above can be described as, but not limited to, the following supplementary notes.

### (Supplementary Note 1)

A method of generating an alert, the method comprising: detecting, in an image frame, a unique parameter of an object using object recognition software;

determining whether the detected unique parameter is associated with an object of interest;

in response to determining that the detected unique parameter is associated with the object of interest, determining whether the associated object of interest has been detected within a deduplication period;

in response to determining that the associated object of interest has been detected within the deduplication period, determining a detection score associated with the detected unique parameter;

determining whether the detection score exceeds a minimal escalation threshold; and

in response to determining that the detection score exceeding the minimal escalation threshold, generating an alert within the deduplication period.

### (Supplementary Note 2)

The method of note 1, further comprising:

in response to determining that the associated object of interest has been detected outside the deduplication period, generating an alert.

### (Supplementary Note 3)

The method of note 1 or 2, wherein the determining of whether the detected unique parameter is associated with an object of interest comprises:

determining feature scores corresponding to features of the detected unique parameter;

comparing the determined feature scores against corresponding feature scores of the object of interest; and

determining a matching score based on the feature score comparison, wherein the detection score is based on the matching score.

### (Supplementary Note 4)

The method of note 3, further comprising:

storing the matching score as the best matching score, wherein the detection score is further based on the best matching score.

### (Supplementary Note 5)

The method of note 3 or 4, further comprising:

determining a frontal score of the detected unique parameter, wherein the frontal score is based on parameters of a device capturing the image frame, and wherein the detection score is further based on the frontal score.

### (Supplementary Note 6)

The method of note 5, further comprising: storing the frontal score as the best frontal score, wherein the detection score is further based on the best frontal score.

### (Supplementary Note 7)

The method of note 6 when dependent on claim 4, wherein the detection score is calculated using an equation of:

A detection score=(max(abs(M2−M1),Tm)*W1)+((Tc+abs(F2−F1))*W2)

wherein M2 is the best matching score; M1 is the matching score; F2 is the best frontal score; F1 is the frontal score; W1 is a first weighting value; W2 is a second weighting value; Tm is a minimum matching threshold; Tc is a frontal camera angle adjustment threshold,
wherein Tm is a minimum delta value between the best matching score and the matching score, and
wherein Tc is a value to adjust the frontal score according to a pitch angle and a yaw angle of the detected unique parameter.

### (Supplementary Note 8)

The method of any one of notes 4 to 6, when note 5 or 6 is dependent on note 4, further comprising:

resetting the best matching score and the best frontal score when the deduplication period expires.

### (Supplementary Note 9)

The method of any one of notes 1 to 8, further comprising:

receiving the image frame from a camera of a video surveillance system.

### (Supplementary Note 10)

The method of any one of notes 1 to 9, wherein the object of interest is on an object of interest list comprising multiple objects of interest.

### (Supplementary Note 11)

The method of any one of notes 1 to 10, wherein the object is a person and the unique parameter is a face of the person.

### (Supplementary Note 12)

A system for generating an alert, the system comprising: a processor;

a peripheral device in communication with the processor, the peripheral device is configured to generate the alert; and

memory in communication with the processor, the memory storing a computer program recorded therein, the computer program being executable by the processor to perform a method of generating the alert, said method comprising:

detecting, in an image frame, a unique parameter of an object using object recognition software;

determining whether the detected unique parameter is associated with an object of interest;

in response to determining that the detected unique parameter is associated with the object of interest, determining whether the associated object of interest has been detected within a deduplication period;

in response to determining that the associated object of interest has been detected within the deduplication period, determining a detection score associated with the detected unique parameter;

determining whether the detection score exceeds a minimal escalation threshold; and

in response to determining that the detection score exceeding the minimal escalation threshold, generating, by the peripheral device, the alert within the deduplication period.

### (Supplementary Note 13)

The system of note 12, wherein the method further comprises:

in response to determining that the associated object of interest has been detected outside the deduplication period, generating an alert.

### (Supplementary Note 14)

The system of note 12 or 13, wherein the determining of whether the detected unique parameter is associated with an object of interest comprises:

determining feature scores corresponding to features of the detected unique parameter;

comparing the determined feature scores against corresponding feature scores of the object of interest; and

determining a matching score based on the feature score comparison, wherein the detection score is based on the matching score.

### (Supplementary Note 15)

The system of note 14, wherein the method further comprises:

storing the matching score as the best matching score, wherein the detection score is further based on the best matching score.

### (Supplementary Note 16)

The system of note 14 or 15, wherein the method further comprises:

determining a frontal score of the detected unique parameter, wherein the frontal score is based on parameters of a device capturing the image frame, and wherein the detection score is further based on the frontal score.

### (Supplementary Note 17)

The system of note 16, wherein the method further comprises:

storing the frontal score as the best frontal score, wherein the detection score is further based on the best frontal score.

### (Supplementary Note 18)

The system of note 17 when dependent on note 15, wherein the detection score is calculated using an equation of:

A detection score=(max(abs(M2−M1),Tm)*W1)+((Tc+abs(F2−F1))*W2)

wherein M2 is the best matching score; M1 is the matching score; F2 is the best frontal score; F1 is the frontal score; W1 is a first weighting value; W2 is a second weighting value; Tm is a minimum matching threshold; and Tc is a frontal camera angle adjustment threshold,
wherein Tm is a minimum delta value between the best matching score and the matching score, and
wherein Tc is a value to adjust the frontal score according to a pitch angle and a yaw angle of the detected unique parameter.

### (Supplementary Note 19)

The system of any one of notes 15 to 17, when note 16 or 17 is dependent on note 15, wherein the method further comprises: resetting the best matching score and the best frontal score when the deduplication period expires.

### (Supplementary Note 20)

The system of any one of notes 12 to 19, further comprising: cameras, wherein each camera is configured to capture a scene as image frames and transmit the image frames to the processor, wherein the image frames are processed by the method of generating the alert.

### (Supplementary Note 21)

The system of any one of notes 12 to 20, wherein the memory stores an object of interest list comprising the object of interest and other multiple objects of interest.

### (Supplementary Note 22)

The system of any one of notes 12 to 21, wherein the object is a person and the unique parameter is a face of the person.

### (Supplementary Note 23)

A computer readable storage medium having a computer program recorded therein, the program being executable by a computer apparatus to make the computer perform a method of generating an alert according to any one of notes 1 to 11.

This application is based upon and claims the benefit of priority from Singapore Patent Application No. 10201805030Y, filed on Jun. 12, 2018, the disclosure of which is incorporated herein in its entirety by reference.

### REFERENCE SIGNS LIST

102 person
110 image frame
210 alert
220 alert
310 video surveillance system
320 camera
600 computer system
604 processor
606 communication infrastructure
608 main memory
610 secondary memory
612 storage drive
614 removable storage drive
618 removable storage medium
622 removable storage unit

1.-23. (canceled)

24. A method of generating an alert, the method comprising:
detecting, in an image frame, a unique parameter of an object using object recognition software;
determining whether the detected unique parameter is associated with an object of interest;
in response to determining that the detected unique parameter is associated with the object of interest, determining whether the associated object of interest has been detected within a deduplication period;
in response to determining that the associated object of interest has been detected within the deduplication period, determining a detection score associated with the detected unique parameter;
determining whether the detection score exceeds a minimal escalation threshold; and
in response to determining that the detection score exceeding the minimal escalation threshold, generating an alert within the deduplication period.

25. The method of claim 24, further comprising:
in response to determining that the associated object of interest has been detected outside the deduplication period, generating an alert.

26. The method of claim 24, wherein the determining of whether the detected unique parameter is associated with an object of interest comprises:
determining feature scores corresponding to features of the detected unique parameter;
comparing the determined feature scores against corresponding feature scores of the object of interest; and
determining a matching score based on the feature score comparison, wherein the detection score is based on the matching score.

27. The method of claim 26, further comprising:
storing the matching score as the best matching score, wherein the detection score is further based on the best matching score.

28. The method of claim 26, further comprising:
determining a frontal score of the detected unique parameter, wherein the frontal score is based on parameters of a device capturing the image frame, and wherein the detection score is further based on the frontal score.

29. The method of claim 28, further comprising:
storing the frontal score as the best frontal score, wherein the detection score is further based on the best frontal score.

30. The method of claim 29, wherein the detection score is calculated using an equation of:
A detection score=(max(abs(M2−M1),Tm)*W1)+((Tc+abs(F2−F1))*W2)
wherein M2 is the best matching score; M1 is the matching score; F2 is the best frontal score; F1 is the frontal score; W1 is a first weighting value; W2 is a second weighting value; Tm is a minimum matching threshold; Tc is a frontal camera angle adjustment threshold,
wherein Tm is a minimum delta value between the best matching score and the matching score, and
wherein Tc is a value to adjust the frontal score according to a pitch angle and a yaw angle of the detected unique parameter.

31. The method of claim 24, further comprising:
receiving the image frame from a camera of a video surveillance system.

32. The method of claim 24, wherein the object of interest is on an object of interest list comprising multiple objects of interest.

33. The method of claim 24, wherein the object is a person and the unique parameter is a face of the person.

34. A system for generating an alert, the system comprising:
a processor;
a peripheral device in communication with the processor, the peripheral device is configured to generate the alert; and
memory in communication with the processor, the memory storing a computer program recorded therein, the computer program being executable by the processor to perform a method of generating the alert, said method comprising:
detecting, in an image frame, a unique parameter of an object using object recognition software;
determining whether the detected unique parameter is associated with an object of interest;
in response to determining that the detected unique parameter is associated with the object of interest, determining whether the associated object of interest has been detected within a deduplication period;
in response to determining that the associated object of interest has been detected within the deduplication period, determining a detection score associated with the detected unique parameter;
determining whether the detection score exceeds a minimal escalation threshold; and
in response to determining that the detection score exceeding the minimal escalation threshold, generating, by the peripheral device, the alert within the deduplication period.

35. The system of claim 34, wherein the method further comprises:
in response to determining that the associated object of interest has been detected outside the deduplication period, generating an alert.

36. The system of claim 35, wherein the determining of whether the detected unique parameter is associated with an object of interest comprises:
determining feature scores corresponding to features of the detected unique parameter;
comparing the determined feature scores against corresponding feature scores of the object of interest; and
determining a matching score based on the feature score comparison, wherein the detection score is based on the matching score.

37. The system of claim 36, wherein the method further comprises:
storing the matching score as the best matching score, wherein the detection score is further based on the best matching score.

38. The system of claim 36, wherein the method further comprises:
determining a frontal score of the detected unique parameter, wherein the frontal score is based on parameters of a device capturing the image frame, and wherein the detection score is further based on the frontal score.

39. The system of claim 38, wherein the method further comprises:
storing the frontal score as the best frontal score, wherein the detection score is further based on the best frontal score.

40. The system of claim 39, wherein the detection score is calculated using an equation of:
A detection score=(max(abs(M2−M1),Tm)*W1)+((Tc+abs(F2−F1))*W2)
wherein M2 is the best matching score; M1 is the matching score; F2 is the best frontal score; F1 is the frontal score; W1 is a first weighting value; W2 is a second weighting value; Tm is a minimum matching threshold; and Tc is a frontal camera angle adjustment threshold,
wherein Tm is a minimum delta value between the best matching score and the matching score, and
wherein Tc is a value to adjust the frontal score according to a pitch angle and a yaw angle of the detected unique parameter.

41. The system of claim 34, further comprising:
cameras, wherein each camera is configured to capture a scene as image frames and transmit the image frames to the processor, wherein the image frames are processed by the method of generating the alert.

42. The system claim 34, wherein the memory stores an object of interest list comprising the object of interest and other multiple objects of interest.

43. The system of claim 34, wherein the object is a person and the unique parameter is a face of the person.
